(19) United States
(12) Patent Application Publication
(10) Pub. No.: US 2024/0199857 A1
(43) Pub. Date: Jun. 20, 2024

(54) CHAOTROPES-ASSISTED DEEP IMMUNOSTAINING

(71) Applicant: The Chinese University of Hong Kong, Hong Kong (CN)

(72) Inventors: Hei Ming LAI, Hong Kong (CN); Chun Ngo Yau, Hong Kong (CN)

(21) Appl. No.: 18/477,775

(22) Filed: Sep. 29, 2023

Related U.S. Application Data
(60) Provisional application No. 63/387,773, filed on Dec. 16, 2022.

(51) Int. Cl. C08L 5/16; G01N 1/30

(52) U.S. Cl. CPC C08L 5/16; G01N 1/30; G01N 2001/302

(57) ABSTRACT

The subject invention pertains to the use of chaotropes and a supramolecular system for histochemical staining. The system includes chaotropic ions and chaotropic ion complexing agents that act as molecular hosts to accept chaotropic ions as a molecular guest. The chaotropic ion promotes diffusion of a probe, such as an antibody into and within a tissue sample with subsequent binding of the guest to the host, or its dilution, to promote association of the antibody with a target antigen and production of an immunostaining or histochemical signal. Alternatively, small-molecule fluorescent probes can act as a molecular guest and complexed by supramolecular host to facilitate its deep penetration. A method for performing histology employs the supramolecular system with a deep homogeneous histochemistry. The method is relatively rapid, scalable, automatable, and cost effective.

### CROSS-REFERENCE TO RELATED APPLICATION

This application claims the benefit of U.S. Ser. No. 63/387,773, filed Dec. 16, 2022, which is hereby incorporated by reference in its entirety including any tables, figures, or drawings.

### BACKGROUND OF THE INVENTION

There is a clinically unmet need in pathology and biomedical research for 3D viewing of tissue samples to better stratify risks of disease progression and detect sinister features, such as the quantity of involved margins and the presence of high-risk molecular markers. The 3D histology method must be scalable at a reasonable cost to translate into a clinical procedure. The method must be scalable with respect to tissue size, time of tissue processing, throughput in the number of samples it can process daily, and reliably produce results with varying sample qualities, such that tissue-based diagnosis and prognosis can become practical and reliable.

Current methods to analyse the distribution and localization of specific proteins within individual cells or tissues is performed using immunostaining. Immunostaining is a standard technique using an antibody targeted against a specific molecule, a primary antibody, to detect its presence. A secondary antibody conjugated with a fluorescent or with an enzymatic tag that binds to the primary antibody allowing its visualization and/or quantified using fluorescence microscope or upon addition of a colouring substrate. The quality of the staining is dependent on the specificity and quality of the primary antibody.

The antibodies for immunostaining can be difficult to penetrate the cells and tissue, and the internalization of impermeable molecules is a challenge for drug development and diagnostic purposes. The poor penetration of the antibody in large blocks of tissues is mechanistically unknown but is thought to be related to the reaction-diffusion process. In brief, although antibodies can move relatively freely in a permeabilized, fully delipidated tissue, its reactions with its target antigens or binding partners (via nonspecific electrostatic interactions) leads to its deposition on the superficial areas of the tissue blocks, depleting them and trapping them from penetrating deeper. Worse still, this leads to inhomogeneous staining as a rim of bright signal is formed only on the superficial areas, but with no deep penetration within the tissue.

Research to improve 3D viewing of tissue samples has been directed to tissue clearing, and several tissue clearing agents are now marketed for research. 3D tissue staining is equally applicable to staining large blocks of tissues with subsequent serial sectioning, leading to the convenient production of pre-stained slices, which is particularly useful for tomography techniques. This new trend of 3D tissue imaging is in parallel to developing new probes, specialized optical objectives, and new programs for visualizing and analysing very large datasets. Current immunostaining techniques for use in 3D histology for clinical samples and tissue diagnostics include eFLASH, ELAST, CUBIC-Histo Vision, SPEARS-ThICK staining, and Transvascular perfusion of antibodies. eFLASH is an electrochemical method that facilitates deep diffusion of antibodies by reducing antibody trapping by superficial antigens, using the detergent sodium deoxycholate at a certain pH, and enhancing antibody mobility, using electric field. eFLASH has been successfully applied to the whole mouse brain or whole marmoset brain for deep, uniform, quantitative immunolabeling, and is applicable to affordable commercially available antibodies. Specialized equipment, though reusable, is expensive and the maximal size of the sample and number of the tissue samples that can be simultaneously processed limits its scalability. ELAST is based on converting the tissue into an elastic material by embedding the tissue in long chains of polyacrylamide in situ. When compressed, the diffusion distance required of macromolecular probes is greatly reduced, facilitating diffusion and deep penetration. In practice, a specialized automated machine is needed to perform serial compression and relaxation; involving considerable work to tear away the excess polyacrylamide gel and manually mount differently sized tissue-gels into the compressing machine, while tissue is rendered fragile and distorted in morphology and structures within the tissue. CUBIC-HistoVision (Cubic-HV) uses chemical buffers which modules the gel-electrolyte properties of tissues to achieve thick tissue staining, including successful staining of whole mouse brains for various antibodies. Unfortunately, the timescale for incubation is extraordinarily long and requires massive amounts of antibodies, after thoroughly delipidating the tissue. SPEARs are thermostabilized antibodies for heat-facilitated deep penetration of antibodies during Thermo-immunohistochemistry with optimized kinetics (ThICK-staining). The time for this method is scalable but the signal intensity is weak, often leading to false negative detection of antigens, and the thermostabilization can result in nonspecific staining. Transvascular perfusion of antibodies operates by directly delivering the probes through patient blood vessels using mass fluid flow. The antibodies then diffuse a short distance from vessels to the nearest antigens. It is assumed that antigens are readily labelled and that the vasculature distribution within tissues is uniform. However, this requires an enormous quantity of antibodies because the perfusion volume is huge, but not all tissues can come with a vessel readily cannulated, hence this is not scalable.

Therefore, an improved histology system for 2D and 3D analysis of tissue samples is needed. To this end a novel in situ supramolecular method that simultaneously improves the penetration depth and homogeneity for immunostaining of thick biological tissue samples is desirable.

### BRIEF SUMMARY OF THE INVENTION

Embodiments of the invention are directed to a supramolecular system for immunostaining. The system includes at least one chaotropic ion to improve tissue penetration and diffusion of at least one probe, where the probe is an antibody, for example, but not limited to, a fluorescence labeled antibody, other protein, or a small molecule within a tissue sample and, optionally, at least one complexing agent that acts as a molecular host to accept the chaotropic ion as a molecular guest to promote association of the probe, for example an antibody with a target antigen, with production of a signal by the end of the experiment. The chaotropic ion can be a perrhenate ion, a closo-borane ion, a closo-carborane ion, or a Keggin-type polyoxometalate of tungsten, molybdenum, tantalum, niobium, or vanadium. The chaotropic ion can be derived from any unsubstituted closo-borane with more than nine atoms, closo-carborane with more than nine atoms, or any mixture thereof, where boron or carbon atoms of the cage are independently substituted with hydrogen, fluorine, chlorine, bromine, iodine, hydroxy group, amino group, or alkyl group. An exemplary chaotropic ion is closo-dodecaborate. The complexing agent can be or possess a functionality that is a cyclodextrin, cucurbituril, calixarene, cyclophane, cryptand, cryptophane, a chemical derivative of any thereof, or an oligomer with anion associating repeating units. Exemplary complexing agents include hexakis-β-glucopyranose (α-cyclodextrin), heptakis-β-glucopyranose (β-cyclodextrin), and octakis-β-glucopyranose (γ-cyclodextrin), wherein independently one or more hydroxy group is optionally replaced with amino, methoxy, (2-hydroxy)propoxy, sulphato, guanidino, phospha, acetamido, azido, bromo, iodo, chloro, toluenesulfonyl, thiol, succinyl, phosphato, 4-sulfatobutoxy, carboxymethoxy or (2-aminoethyl)amino group. In some embodiments, the complexation agent can be omitted where the effect of closo-dodecaborate, or other chaotropic ion is simply diluted by water or any chemical buffer system.

The supramolecular systems can employ a chemical buffer system, such as, but not limited to, Good's buffering agents, phosphate-buffered saline, Tris, CAPS, HEPES, or any combination thereof. The buffer system can have a pH 6-11 and be included at a concentration of 10-1000 mM, for example, 1×PBS at pH 7-8. The chaotropic ion and a chaotropic ion complexing agent can be provided in separate vehicles for separate introduction to the tissue sample.

An embodiment of the invention is directed to a method for performing histology, either 2D or 3D, where the above supramolecular system for immunostaining is used with a tissue comprising sample that is incubated with the chaotropic ion of the supramolecular system to form an incubated sample. The incubated sample undergoes combining with the chaotropic ion complexing agent of the supramolecular system to promote an association of an antibody with a target antigen with generation of a signal. The combining can be in a subsequent step to incubating. The signal can then be imaged, analyzed and quantified. The tissue comprising sample is from a mammal, for example a mouse or a human, for experimental or clinical purposes. The tissue can be an entire organ or a portion thereof. The tissue comprising sample can be a tissue slice of about 1 to about 100 μm in thickness, which can be obtained by frozen sectioning, vibratome sectioning, or paraffin sectioning and can be fixed using formalin-fixation, glutaraldehyde-fixation, methanol-fixation, ethanol-fixation, glyoxal-fixation, picric acid-fixation, trichloroacetic acid-fixation, polyacrylamide-formalin-fixation, polyglycerol 3-polyglycidyl ether-fixation, or combinations thereof. Particularly for 3D histology, optical tissue clearing and tomography can be employed with any known protocol.

### BRIEF DESCRIPTION OF THE DRAWINGS

FIG. 1A shows chaotropic ion structures of closo-dodecahydrododecaborate and derivatives thereof.

FIG. 1B shows structures of various chaotropic ion.

FIG. 2A shows structures of the complexing agent cyclodextrins.

FIG. 2B shows structures of complexing agent from cyclodextrins and derivatives thereof.

FIG. 3 shows the steps of a method according to an embodiment using a supramolecular system (INSIGHT) according to an embodiment, for deep staining illustrated with a tissue external view, top row, and a tissue internal view, bottom row, that suggests the interaction of components to achieve the desired homogeneous deep staining.

FIG. 4 outlines an experimental design used for benchmarking antibody penetration depth and homogeneity using a mouse hemibrain followed by bulk-staining tissue cutting to a plane channel and repeated staining of the cut channel with analysis of the channel before (bulk-staining channel) and after the repeated staining (cut-staining channel).

FIG. 5 shows representative images from a sample in the benchmarking experiment with INSIGHT, where the XY-plane is displayed for the bulk-staining (upper row) with its corresponding calculated penetration lengths (insets of upper row) that are relative invariant for the same Z-depth of imaging (organized in columns) and the XY-plane is displayed for cut-staining (lower row) through the cut surface (the imaging plane), here (lower row), where the penetration distance was bumpy and inhomogeneous due to slight tissue curvatures and irregular tissue texture, that are taken into account during quantification of cut-staining penetration depth (insets, of lower row).

FIG. 6 is a plot of the ratio of the bulk-staining intensity to the cut-staining intensity for different γ-cyclodextrin derivatives using the benchmarking experiment in contrast to a commonly used zwitter-ion detergent CHAPSO.

FIG. 7 shows the bulk-staining images for INSIGHT and five available imaging systems used for deep immunostaining.

FIG. 8 shows a plot of the bulk-stain global cell segmentation vs penetration distance relative to a hypothetical ideal performance.

FIG. 9 shows an x-z projection of white boxed areas in FIG. 7 at deep bulk-staining penetration depths, with only the cut-staining channels shown, where the deeper the penetration, the more permeabilized the tissue.

FIG. 10 is a plot of the cut-staining intensity vs the cut-staining penetration depth for quantitative comparison of tissue permeabilization by INSIGHT and five available imaging systems.

FIG. 11 is a bar chart indication the number of validated compatible antibodies for INSIGHT and five available imaging systems.

FIG. 12 is a segmented bar chart of the process timeline for INSIGHT and five available imaging systems drawn to scale without consideration of somewhat equivalent washing steps employed in all systems.

FIG. 13 shows a schematic of a lateral flow rapid antigen test (RAT) kit for use to validate the mechanism of supramolecular histochemistry operation as a reaction-diffusion model with photographs of RATs when different concentrations of [B₁₂H_{12]}²⁻ added to the sample pad.

FIG. 14 illustrate experimental steps (upper row) and corresponding principle (lower row) of supramolecular histochemistry where tissue is infiltrated with primary antibodies, fluorescently labeled secondary antibody Fab fragments, and a chaotropic ion (chaotropic agent) that is infiltrated into tissue, transferred into a washing solution containing a chaotropic complexation agent or a dilution solution.

FIG. 15 shows a nucleic acid probe (NAP), and its complexation by sulfobutylether-β-CD (SBE-β-CD) for an alternative supramolecular histochemistry strategy for enhanced probe penetration into tissues.

FIG. 16 shows a chart for an enhanced penetration depths of [DAPI⊂SBE-β-CD] in the method according to an embodiment in contrast to DAPI in a state of the art histology staining.

FIG. 17 shows the bulk-staining images effect of whole mouse brain multiplexed immunostainings in the absence, iDisco, versus presence of [B₁₂H₁₂]²⁻, INSIGHT, despite using the same tissue processing parameters.

### DETAILED DISCLOSURE OF THE INVENTION

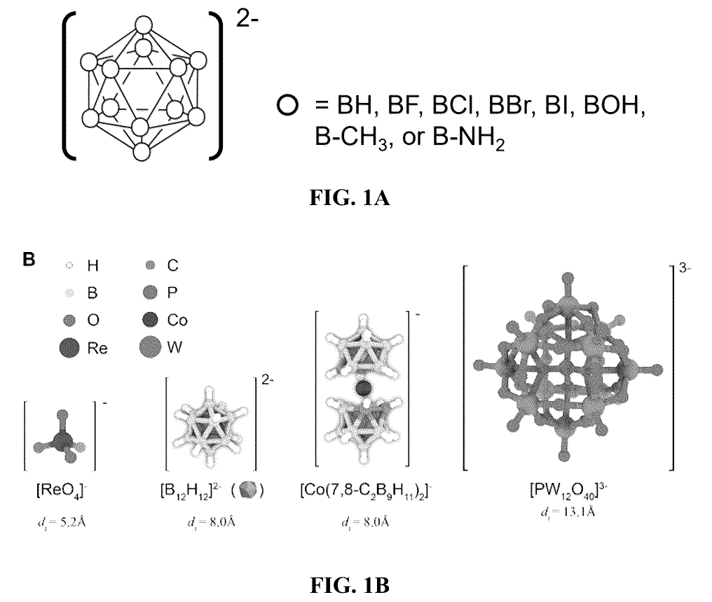

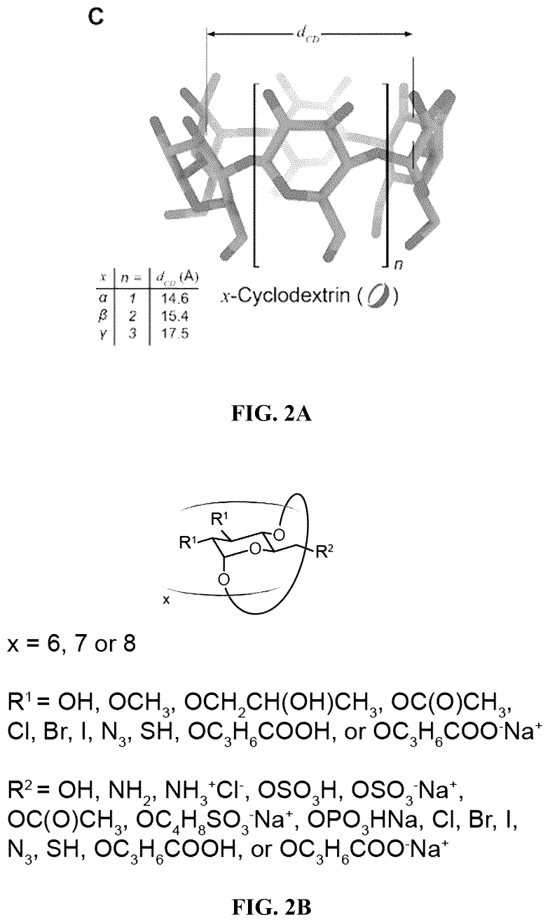

Embodiments are directed to an in situ supramolecular chemistry system (INSIGHT) for improving the penetration depth and homogeneity of penetration in 2D or 3D immunostaining for analysis of one or more target antigens in biological tissues, which may be the thickness of the tissue. The system allows a homogeneous deep immunostaining of thick tissues with optical clearing to enhance 3D imaging using optical sectioning microscopy techniques. The system includes a chaotropic salt to provide a chaotropic ion, a probe, and optionally a complexing agent, to perform the 3D immunohistochemistry. The chaotropic salt, can be any perrhenate ion, closo-borane ion, closo-carborane ion, cobalt bis(dicarbollide) ions (CoSAN) or polyoxometalate of tungsten, molybdenum, tantalum, niobium, or vanadium, such as phosphotungstate and phosphomolybdate ions. In an embodiment the chaotropic salt can be, but not limited to, sodium dodecahydrododecaborate (Na₂B₁₂H₁₂) provides a chaotropic anion, such as, [B₁₂H₁₂]²⁻, as shown in FIG. 1A, or an anion derived from any unsubstituted closo-borane or closo-carborane in excess of 9 atoms within the cage where the boron or carbon atoms can be independently substituted with fluoro, chloro, bromo, iodo, hydroxy, amino, or alkyl group. The salt can have a cation that can be, but is not limited to, any alkali metal, alkali earth metal, The chaotropic anion is employed to inhibit aggregation with denatured antibodies and to inhibit the interactions between antigen and functional antibodies. The complexing agent that can be employed with the chaotropic anion can be, but not limited to: γ-cyclodextrin (γCD), shown in FIG. 2A; other cyclodextrins, shown in FIG. 2B; cucurbiturils, calixarenes, cyclophanes, cryptands, cryptophanes, chemical derivatives of any thereof, or oligomers with anion associating repeating units. Cyclodextrins can be hexakis-β-glucopyranose (also known as α-cyclodextrin), heptakis-β-glucopyranose (also known as β-cyclodextrin), octakis-β-glucopyranose (also known as γ-cyclodextrin), and their derivatives, having the general structure is displayed in FIG. 2B, where hydroxy groups can be replaced with amino, methoxy. (2-hydroxy)propoxyl, sulphato, guanidino, acetato, acetamido, azido, bromo, iodo, chloro, toluenesulfonyl, thiol, succinyl, phosphato, 4-sulfatobutoxy, carboxymethoxy or (2-aminoethyl)amino groups. This chaotropic salt is provided for co-incubation with a probe, such as, but not limited to, primary antibodies or antigens and the functionalized antibody, such as a fluorescently labelled fragment antigen-binding secondary antibody (Fab) or single-domain antibody (also known as VHH antibody or nanobodies), selected for binding with the target primary antigen, in the tissue sample. Probes can be other proteins or small molecules, such as multiple fluorescently or dye tagged lectins, dye tagged streptavidin or avidin derivatives, dye tagged protein tags (e.g., SNAP-tag, CLIP-tag, Spy tag), or dye tagged protein binders designed with computer softwares or deep neural networks, cationic oligopeptides, DAPI (4′,6-diamidino-2-phenylindole), Hoechst dyes, thiazole orange and its derivatives, oxazole blue and its derivatives, propidium iodide, eosin, lipophilic dyes (such as DiI, CM-DiI, DiD, DiR, and DiO), nuclear red, methylene blue, methyl green, cresyl violet, bromophenol red, alizarin red S, and malachite green.

The chaotropic anions enhance diffusion through the cell membranes and inhibit secondary antibodies from binding their tissue antigen targets as they infuse into the tissue, allowing the probe secondary antibodies to diffuse freely throughout the tissue without consumption by fixed tissue antigens. The molecular host, which avidly binds and removes [B₁₂H₁₂]²⁻ or other chaotropic anions, enabling the homogeneously distributed secondary antibodies to bind the target antigens deep within the tissues, achieving the deep high quality 3D immunohistochemistry. The chaotropic anions and the chaotropic anion complexing agent can be provided in separate vehicles to fix the chaotropic anion and associated antibodies into the tissue and then upon subsequent transfer of the incubated tissue into a solution of molecular host complexing agent to disinhibit the associated antibodies to bind the target antigens.

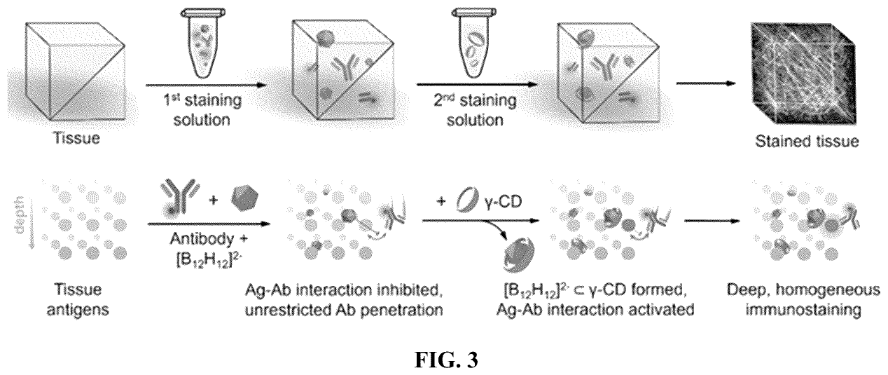

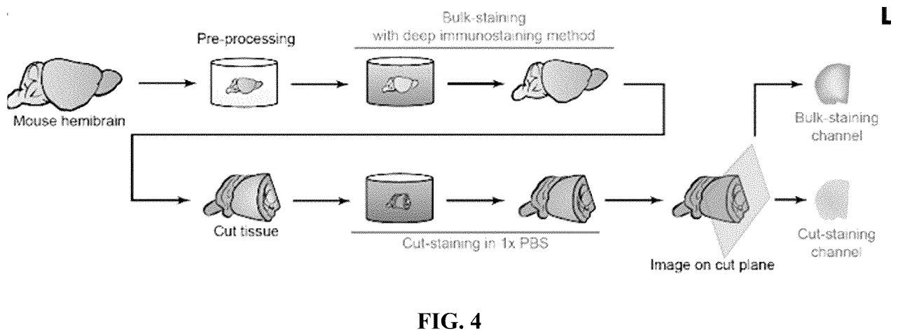

An embodiment of the invention is to a method of 3D analysis of a target antigen enabled by the INSIGHT system, where, as illustrated in FIG. 3, the chaotropic anion, shown as [B₁₂H₁₂]²⁻, is infiltrated into the tissue containing the primary antibody using a first staining buffer with a fluorescently labelled secondary antibody Fab and [B₁₂H₁₂]²⁻ at room temperature for a desired period of time to provide antibody-infiltrated tissue. Transferring the antibody-infiltrated tissue into a second staining buffer containing the molecular host, shown as γ-CD in FIG. 3, which diffuses into the tissue and complexes with [B₁₂H₁₂]²⁻, to release chaotropic anion bound antibodies and promote the binding of the Fab antibodies to the target antigen(s). Fluorescence imaging of the labelled secondary antibody Fab antigen pair allows an imaging in 2D or 3D. A tissue clearing agent and technique, such as, but not limited to, those of CLARITY, CUBIC, SWITH, SHIELD, BABB, iDISCO, pathoDISCO, uDISCO, vDISCO, 3DISCO, Fluoro-BABB, Ce3D, ScaleS, SeeDB, SeeDB2S, OPTIClear, OPTIClear2, SHANEL, or PEGASOS, can be employed for deep 3D analysis.

The supramolecular histochemistry method according to embodiments addresses limitations of traditional histochemical staining techniques, which often suffer from uneven penetration and nonspecific binding of probes that lead to suboptimal signal-to-background and signal-to-nonspecific ratios. By employing a unique combination of reagents and processing steps, supramolecular histochemistry, according to embodiments, allows homogeneous and deep penetration of antibodies, lectins, and small molecule probes into the sample, resulting in improved staining specificity and enhanced visualization of target structures.

Homogeneous Penetration occurs as supramolecular histochemistry ensures the uniform distribution of probes throughout the sample, allowing for consistent and accurate staining of target structures. This is particularly important for thick or dense samples, where traditional staining methods may struggle to achieve adequate penetration. An unbiased quantitative data arises from the high degree of homogeneity of penetration, which provides unbiased data across the penetration depth, and, hence, provide quantitative reflection of the ground truth signal for each detected biomolecular target. The deep penetration of the method enables the probes to reach deep into the sample, ensuring that even structures located far from the surface are effectively stained. This is crucial for the analysis of complex biological samples, such as tissues and organs, where important information may be hidden deep within the sample. Because of the increased staining specificity, the supramolecular histochemistry modulates the nuances of antibody-antigen interaction dynamics and hence provides simultaneous boosting of immunofluorescence signal-to-background and signal-to-nonspecific ratios, supramolecular histochemistry provides clearer and more accurate visualization of target structures. This is particularly important for detection of low-abundance targets, difficult antibodies or when distinguishing between closely related structures or telling signal from autofluorescence. Supramolecular histochemistry has nearly universal applicability to tissues and probes, being compatible with a wide range of off-the-shelf probes, including antibodies, lectins, and small molecule probes, as well as diverse tissues from plants to animal to clinical archived or fresh frozen tissues or organoids, chimeric tissues or explants/xenografts, making it a versatile method for research and clinical use. The in situ supramolecular chemistry is simple in operation, providing chemical means to control the tissue-wide behavior of probes in a complex environment. Operationally this is extremely simple and only involves adding certain well-defined, low cost additives to the usual staining solutions, without the use of any specialized equipment or expertise. This is crucial for future applications in tissue diagnostics where automatability, scalability, reliability, cost, parallelizability, and market readiness are key to widespread adoption.

Histological examination of tissue in three dimensions can reveal previously unknown structural organization principles that improve disease diagnosis and prognosis when a biopsy or resection is indicated. However, even with advances in clearing whole animals or entire human organs, the achievable depths of probe penetration into tissues have typically been limited to a few hundred micrometers. Antibodies especially have varied performance under different conditions and low concentrations. This represents the most significant barrier to scaling up 3D histology, restricting applications to serial sectioning and staining, or transgenic animals with endogenous fluorescence when tissue clearing is used. While recent approaches have tackled this problem, they fall short in key attributes of an ideal method: staining quality, reliability, scalability, ease of use, speed, compatibility with multiplexed and multimodal labeling, and costs. These shortcomings hinder wider adoption in research and clinical settings. Additionally, signal homogeneity across penetration depth is suboptimal with most methods, complicating quantitative protein expression determination. In summary, 3D histological techniques according to embodiments are potentially powerful but probe penetration depth currently limits their applications. Existing methods to improve penetration lack key attributes for widespread adoption, indicating the need for new solutions.

Technical bottlenecks are addressed by the supramolecular histochemistry according to embodiments, achieving a user-friendly 3D histochemistry method, featuring: homogeneous probe penetration up to centimeter depths; quantitative, highly specific immunostaining signals; fast, low-cost, and highly scalable to accommodate different tissue sizes and shapes: simple immersion-based staining, thus easily adopted in any laboratory and readily automatable; and use of off-the-shelf antibodies or probes and is directly applicable to wild-type mouse and human tissues. This suite of technology utilizes in situ supramolecular reaction systems, including a boron cluster compound closo-dodecahydrododecaborate and γ-cyclodextrin derivatives, to achieve switchable modulation of probe-target interactions throughout the tissue and attain homogeneous, deeply penetrating 3D histochemistry.

To design a reliable, automatable and scalable 3D histochemistry method, a chemical approach to increase molecular mobility in tissue matrices was embraced. The use of reversible, bio-orthogonal non-covalent click-chemistries in supramolecular systems is ideally suited for this method. Based on the reaction-diffusion model of probe motion in tissues, two complementary, yet compatible, supramolecular histochemical approaches of a switchable chaotropic system, for globally controlling intermolecular interactions, and a supramolecular carrier approach, for creating a probe-selective mobility stream across the tissue matrix.

In 3D immunostaining, the relative rates of various chemical reactions involving antibodies (e.g., antigen binding, non-specific tissue binding, clumping) and their diffusive movements determine the ultimate distribution of antigen-bound antibodies in the tissue matrix. In the switchable chaotropic approach, chaotropes that are known to reduce solvent viscosity and global protein-protein interactions, facilitate probe diffusion through the matrix. After homogeneously distributing protein probes throughout the tissue, the chaotropes can be removed using a supramolecular host with matched cavity size for their bio-orthogonal removal via an enthalpy-driven complexation process. The recovery in water structure re-provides the driving force for antibody-antigen interactions throughout the tissue. In the supramolecular carrier approach, mobile supramolecular hosts complex the probes as guest molecules are added, favoring probe partition to the solution phase versus being fixed tissue targets. This is equivalent to decreasing the reaction rate between the probe and its tissue targets due to an additional host-guest dissociation step, hence favoring probe diffusion. Alternatively, supramolecular hosts can be viewed as molecularly sized organic solvent “pockets” that enhances the dissolution of probe-target precipitate, which has minimal impact on protein functioning essential for immunostaining when compared with organic solvents.

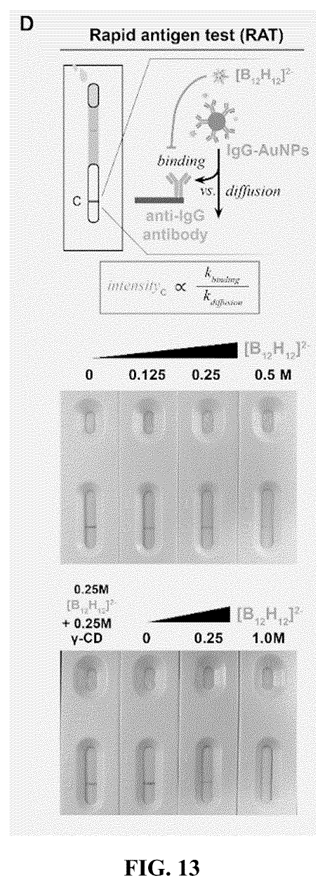

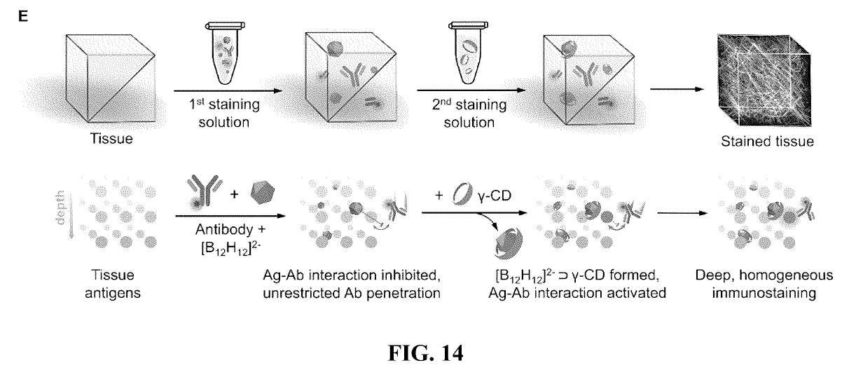

Highly chaotropic, weakly coordinating anions were screened for application to the switchable chaotropic approach that minimizes the denaturation of proteins by enthalpy-driven structure melting and provide sufficient enthalpic driving forces for in situ supramolecular reaction. Using a standard deep immunostaining benchmarking protocol the performances of several supramolecular systems: perrhenate/α-cyclodextrin (ReO₄⁻/αCD); closo-dodecaborate ions [B₁₂X₁₂]²⁻/γCD (where X=H, Cl, Br, or I); metallacarborane [Co(7,8-C₂B₉H₁₁)₂]⁻/γCD; polyoxometalates [PM₁₂O₄₀]³⁻/γCD (where M=Mo, or W), as shown in FIG. 1B; and deoxycholate/PCD, were compared for in situ in deep immunohistochemistry. Only ReO₄⁻, [B₁₂H₁₂]²⁻, [Co(7,8-C₂B₉H₁₁)₂]⁻, and deoxycholate proved compatible with immunostaining conditions without causing tissue destruction or precipitates, whereas the deoxycholate/βCD system caused undesirable intravascular precipitates. Comparing the performances of ReO₄⁻, [B₁₂H₁₂]²⁻, and [Co(7,8-C₂B₉H₁₁)₂]⁻, the best staining sensitivity, specificity, and signal homogeneity across depth was observed using [B₁₂H₁₂]²⁻/γCD, while the effect of derivatizing γCD was negligible. The differential effects of [B₁₂H₁₂]²⁻ and its corresponding supramolecular complex [B₁₂H₁₂]²⁻⊃2HP-γCD in modulating antibody-antigen interaction was validated with the SARS-CoV-2 rapid antigen test as a reaction-diffusion implementation model, as shown in FIG. 13. Using the more soluble 2-hydroxypropylated derivative (2HP-γCD) for its higher water solubility, the deep immunostaining part in the INSIGHT protocol was established, as shown in FIG. 14, which involves incubating the tissue in [B₁₂H₁₂]²⁻/PBS with antibodies, then in 2HP-γCD/PBS. The whole process involves only a simple exchange of two buffers with non-hazardous chemicals, incubation temperatures of 20 to 37° C., and no special equipment.

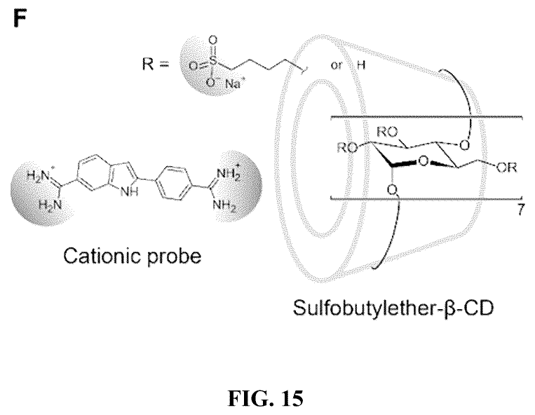

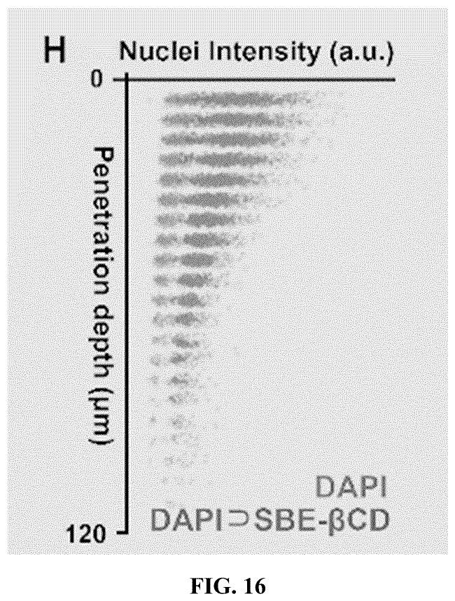

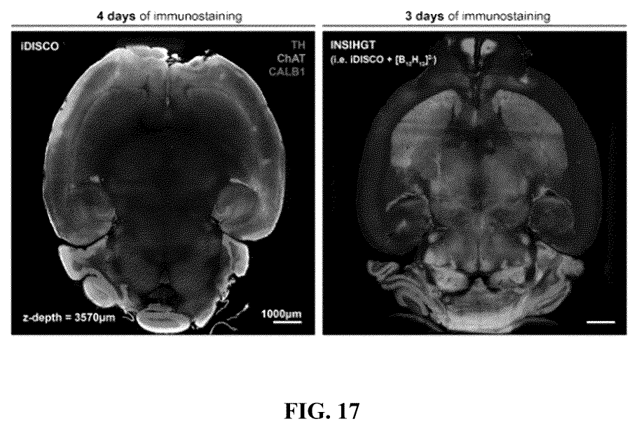

For small molecule dyes, size-matched and charge-complementing cyclodextrin derivatives are cost-effective supramolecular host carriers for deep tissue penetration. For example, sulfobutylether-βCD (SBE-βCD), as shown in FIG. 15, can form a high-affinity supramolecular complex with nucleic acid probes, which are mostly positively charged. The mobile [probe⊂SBE-βCD] species that is formed exhibits penetration enhancement during INSIGHT, as indicated in FIG. 16, and inhibits formation of [probeⁿ⁺]/[B₁₂H₁₂²⁻] precipitates. The [probe⊂xCD] complex displayed increased mobility in boiled egg whites as a proteinaceous matrix, confirming that nonspecific interactions between probes and tissue components can be significant in the reaction-diffusion model. Hence, the replacement of non-denaturing detergents (e.g., Triton X-100, Tween-20) with a boron cluster-based host-guest system, and small molecule probes with probechost complexes, enable the scaling of traditional section-based histochemistry to three-dimensions.

The INSIGHT system improves immunostaining quality relative to prior art systems with respect to maximizing specific staining, minimizing non-specific staining, increasing overall signal intensity, increasing immunostaining penetration depths in thick tissues, improving homogeneity of immunostaining across penetration depths in thick tissues, and improving protein signal intensity (generally, but not necessarily fluorescence, in tissues). Maximizing specific staining is with respect to attaining higher signals in areas where the antibody is expected to produce a signal as indicated: in immunostaining examples described in literature; by antibody vendors; by theoretical predictions based on existing databases; or from experts familiar with the secondary antibody and its antigen in relation to the specific experimental conditions employed. Minimizing nonspecific staining is the reducing or eliminating signals in areas that are not expected to generate a signal. Increasing overall signal intensity is with respect to the total summed signal from the sample. An increase in immunostaining penetration depth is respect with the ability to detect specific staining at greater distances from the nearest tissue surface than that observed for current systems for histology. Improvement in homogeneity of immunostaining across penetration depths implies superior signal intensity and contrasts for specific staining at greater tissue depths relative to those specific staining at lesser tissue depths where improvement implies that the ratio of greater to lesser depth signal is closer to unity than other systems. The improvement in fluorescent protein signal in tissues is applicable to tissues with endogenously expressed fluorescent proteins. An increase in signal and image contrast can be endogenous or exogenous.

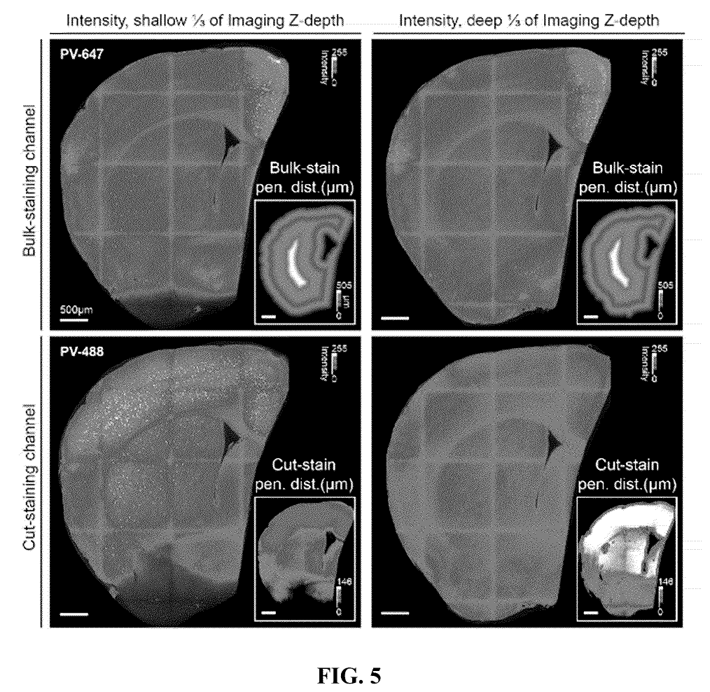

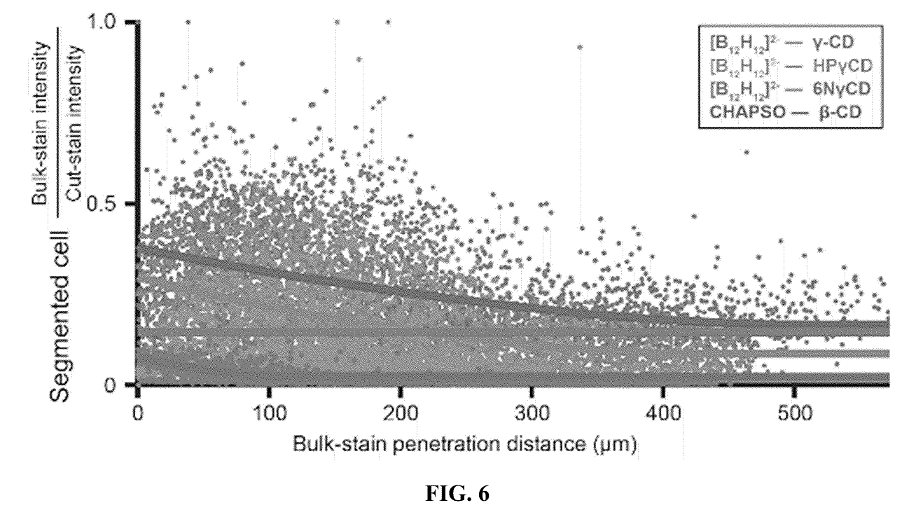

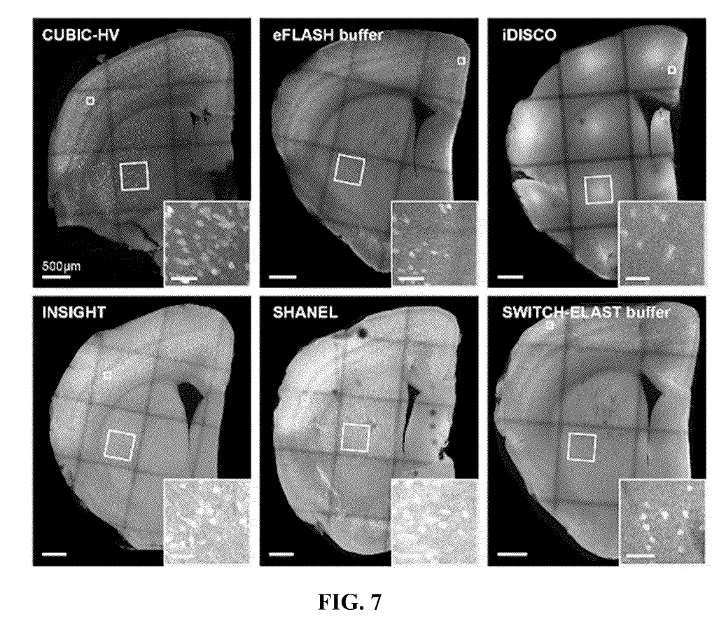

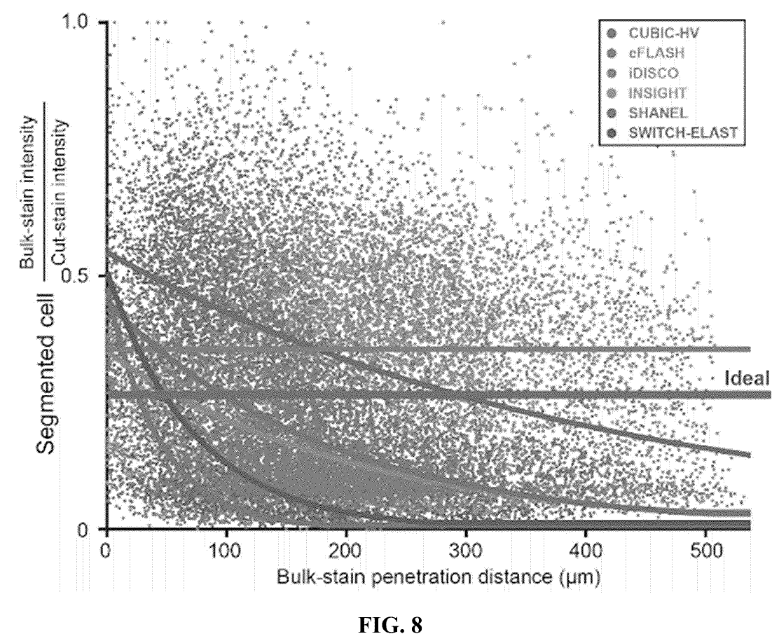

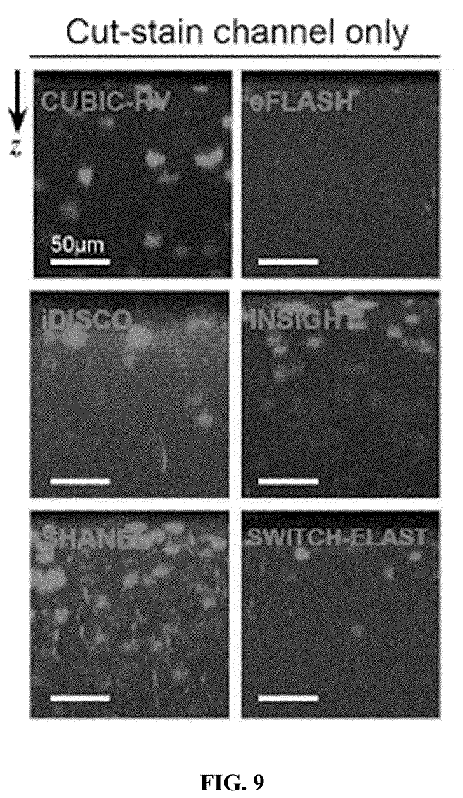

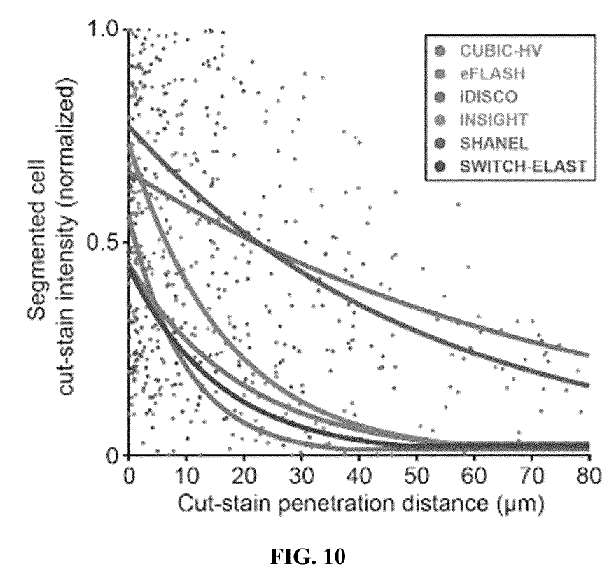

Quantitative benchmarks for the performance of INSIGHT with other experimental methods is probed using a stringent experimental design, as illustrated in FIG. 4 with the result in FIG. 5. This allows comparison of the difference of the imaging of a plane from bulk-staining of the entire tissue sample and imaging of a subsequent second staining of the cut-staining of a sample cut to that image plane prior to staining to compare the intensity of the fluorescence with depth to derive optimal conditions with various molecular hosts and the chaotropic anion compositions for INSIGHT, as indicated in FIG. 6. This benchmarking experiment, FIG. 4, was carried out in two stages; the first being the staining of an adult mouse brain using a deep immunostaining method (termed bulk-staining) and cutting to form a cut plane, followed by re-staining the cut sample with the same primary antibody using conventional immunostaining buffer 1×PBS with 0.1% Tween-20 (termed cut-staining). It was found that INSIGHT produced the deepest immunostaining with the best homogeneity across the entire penetration depth, which is near-ideal staining, as indicated in FIG. 7 and superior to current deep imaging methods FIG. 8. Comparison of the cut-staining intensity against the cut-staining penetration distance, as illustrated in and FIGS. 9 and 10. Clearly INSIGHT does not rely on permeabilization of tissues in contrast with other methods, such as SHANEL and CUBIC-HV.

INSIGHT's function involves reducing antibody motion drag by reducing its viscosity in tissues, hence enhancing diffusivity by removing a reaction barrier by inhibiting the antibody from being consumed by fixed tissue antigens during its distribution stage throughout the tissue to transport the Fab antibody deeply and homogeneously throughout the tissue. The chaotropic effect provides a large driving force, via an enthalpy gain in bulk water solvent by specific complexation to γCD and hence the chaotropic anion's “deactivation” to remove inhibition of the antibody-antigen binding reaction at the later staining stage as a rapid chemical “switch”.

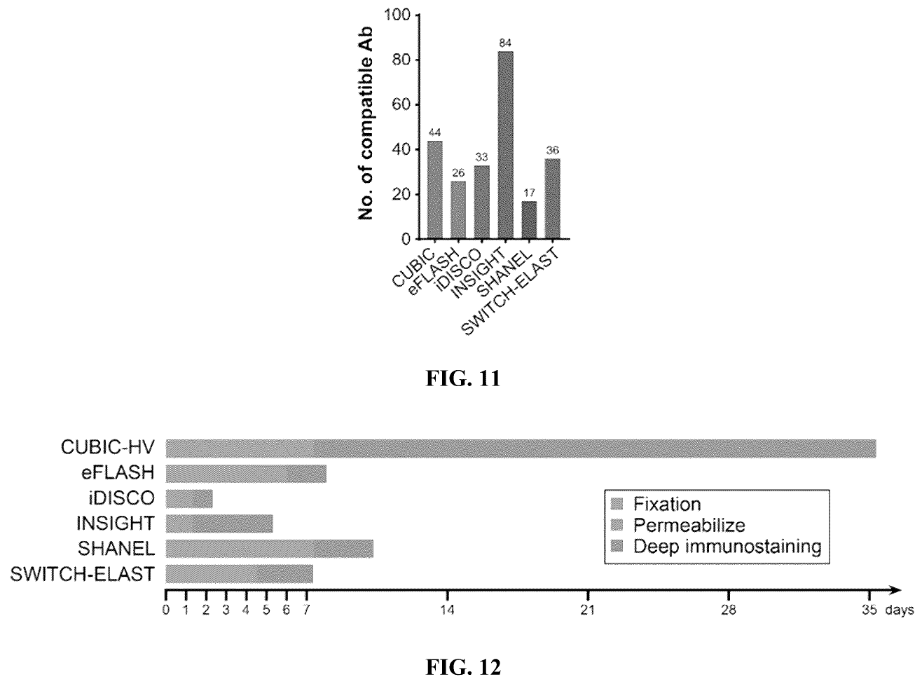

The generalizability of INSIGHT, compared well to other tested systems. INSIGHT is excellent, displaying the greatest number of validated antibodies, 85 out of 90, as indicated in FIG. 11, that are compatible, where antibodies were found to perform better when INSIGHT is employed than any conventional immunostaining methods for 72 of the 90 tested antibodies. This is consistent with the INSIGHT method involving a molecular “chaperoning” effect of the [B₁₂H₁₂]²⁻γCD system, that allows refolding of the chaotropic anion denatured commercial primary antibodies to recover their function. INSIGHT is particularly advantages in its simplicity of operation allowing it to be fully automatable, with a short time of tissue processing, as indicated in FIG. 12, low cost, and does not require the use of any specialized equipment, hence easily adoptable by all basic laboratories.

INSIGHT complements developed clearing agents, which require a deep immunolabeling method to exemplify their clearing powers. INSIGHT address the bottleneck to implementation of 3D immunofluorescence analysis, which is an achievement of adequate penetration of antibody probes at reasonable costs and labour efficiencies. Clinical use is facilitated with an automated system for 3D imaging of tissue that combining efficient tissue clearing, deep immunostaining, and fast optical section imaging. Current state-of-the-art systems for automatable tissue clearing and optical section imaging solutions can be augmented with INSIGHT to achieve: a reliable immunofluorescence signal, displaying low non-specific signals amongst the desired high specific signal; reproducible penetration depths, with homogeneous staining across the greatest depth possible; a low cost; reasonable speed, which can be less than 48 hours; scalability with respect to tissue size, allowing similar operation regardless of the tissue sample's size; and ease of operation, such that it can be automated. As can be seen in Table 1, below, of all available deep staining technologies, only INSIGHT fulfils all the criteria, as indicated above, for clinical use.

TABLE 1
Comparison of readiness of different deep immunostaining systems for
use in 3D histology for clinical samples and tissue diagnostics.

| | | | | | Highly | |
|---|---|---|---|---|---|---|
| | | High | | High speed | scalable | |
| | Achieving | specific-to- | | (centimeter- | with | |
| | homogeneous deep | nonspecific | Low | scale staining | respect to | |
| System | immunofluorescence | signal ratio | cost | in <48 hours) | tissue size | Automatable |
| INSIGHT | Yes | Yes | Yes | Yes | Yes | Yes |
| eFLASH | Yes | Yes | No | Yes | No | No |
| Transvascular | Yes | Yes | Yes | Yes | No | No |
| perfusion | | | | | | |
| ELAST | Yes | Yes | Yes | Yes | No | No |
| CUBIC | Yes | Yes | Yes | No | Yes | Yes |
| HistoVision | | | | | | |
| SPEARs with | Yes | No | Yes | Yes | Yes | Yes |
| ThICK staining | | | | | | |

This novel technology is far-reaching, having potential applications in tissue diagnostics and research. For diagnostics, the homogeneous penetration throughout entire tissue specimens enables highly precise and standardized quantification of dozens of markers, reducing false positives and negatives for more definitive disease diagnosis from biopsy samples. The deep penetration provides information from all tissue regions, revealing early changes and heterogeneity that surface-only analysis misses. Combined with its simple workflow, cost-efficiency, and potential for high-throughput, this technology transforms tissue-based disease diagnostics. For research, the unbiased, quantitative 3D mapping of multiple markers provides an unprecedented view of tissue physiology, facilitating new discoveries about how diseases alter tissue organization in situ. The high throughput, parallelizable workflow, deep penetration, and quantitative capabilities create new opportunities for drug development and precision medicine, for example in the search of latent markers that may provide new indications for old drugs. This technology provides a means to directly measure drug responses in situ throughout entire 3D tissue and organoid models, enabling the design of more effective and targeted therapies. The simple workflow, cost-efficiency, and potential for high volume sample processing open new avenues for clinical diagnostics and mass screening to enable earlier disease detection and improved patient outcomes.

This supramolecular histochemistry method has the potential to revolutionize the field of histochemistry by providing a more effective and reliable staining technique for the analysis of biological samples. Potentially, the emergence of a disruptive chemical process is possible, having the potential to revolutionize 3D histology that is more accessible and widely adopted in mainstream research and tissue diagnostics. It can enable researchers and clinicians to obtain high-resolution 3D images, leading to a deeper understanding of diseases. Moreover, the simplicity and automation of the process would make it user-friendly, allowing researchers with minimal training to perform tissue analysis. Hence, this technology can lead to the democratization of 3D histology as a subject, driving new research frontiers, collaborations, knowledge sharing, and ultimately improving diagnoses, treatment approaches, and patient outcomes through precision medicine.

The supramolecular histochemistry can be employed using either of two different strategies, being a chaotropic strategy or a complexation strategy. In the chaotropic strategy during multiplexed indirect immunohistochemistry, primary antibodies originated from different host species (rat, mouse, pig, goat, rabbit, sheep, guinea pig, donkey, lama, camel and horse) can be combined and added to the staining solution directly and in combination with a monovalent secondary antibody Fab fragments (from rat, mouse, pig, goat, rabbit, sheep, guinea pig, donkey, lama, camel, horse and cow) or with single domain antibodies from lama or alpaca against the different species used for the primary antibodies. Signal amplification with immunohistochemistry is compatible. For example, biotin-labelled secondary antibody reagents with fluorescently labelled streptavidin added subsequently in any steps in combination with the supramolecular complexing hosts molecules (chaotropes), the stains, the lectins, or other antibodies, but not with the biotin-labelled secondary antibody reagents, to boost the signal intensity. Lectin histochemistry is also compatible in this strategy, where one or multiple fluorescently or dye tagged lectins' penetration depth, homogeneity, and quality can be enhanced with supramolecular histochemistry. The supramolecular histochemistry can be performed iteratively in cycles on the same piece of tissue, leading to multiple rounds of different images on the same organ. This is possible by the use of the chaotropes combined with sodium sulphite or beta-mercaptoethanol to elute antibodies from the tissue block and allow another round of supramolecular histochemistry. This method is compatible with tissue having endogenously expressed fluorescent proteins, where their fluorescent signals would not be degraded. The method can be perform using either strategy in conjunction with any current histological stains and immunohistochemistry and lectin histochemistry techniques to enhance the performance of those histology methods.

The tissue is not destroyed nor is its composition disrupted after the supramolecular histochemistry process leaving it compatible with downstream analyses, such as extraction of nucleic acids for analysis using PCR, northern and southern blotting, in situ hybridization (ISH), RNA or DNA sequencing, and extraction of proteins for western blotting, gel electrophoresis, mass spectrometry, or ELISA. The tissue used can subsequently be viewed or imaged in physical tissue sections after cutting or cleared with optical tissue clearing methods and viewed in optical sections.

The supramolecular histochemistry method is compatible with and can be performed before, during and after: tissue immunohistochemical treatment; immunocytochemical treatment; in situ hybridization process; fluorescent in situ hybridization process; chromosome identification process; the dyeing process; an antigen retrieval process; a blocking process, a cytochemical treatment; a molecular chemical treatment; an epitope recovery process; a pretreatment process; a tissue permeabilization process; a tissue clearing process; a tissue dehydration process; a tissue rehydration process; a tissue delipidation process; a tissue fixation process; a tissue washing process; and/or a tissue retrieval process from paraffin wax blocks. The method allows establishment of an automated, rapid, scalable, and cost-efficient procedure for obtaining multiplexed stained whole blocks of tissues for 3D histology in research and clinical tissue diagnostics uses.

### Methods and Materials

### General Supramolecular Histochemistry Procedure

Any fixed biological tissue samples can be used. Any appropriate tissue pre-processing can be used as desired. The adequately washed tissue can proceed directly to supramolecular histochemistry as they would for normal histochemistry.

The tissue is pre-incubated in a solution with desired composition of the user's choice with the addition of 0.01-1M of a chaotrope at 15-55° C. for two minutes to twelve hours with optional shaking. The detection of biomolecular targets occurs using antibodies, lectins, small molecule dyes that are optionally pre-complexed with its supramolecular host in the presence of an added 0.01-1M chaotrope at 10-37° C. for five minutes to two weeks with optional shaking, on top of a usual staining solution composition. Subsequently, the staining solution is diluting with a solution having a desired composition or the staining solution is replaced with the wash solution, with incubating condition at 4 to 37° C. for five minutes to one week. The solution may contain a supramolecular host molecule that complexes the chaotrope residing in the tissue. Any subsequent imaging, histological or tissue analyses can ensue as desired in the traditional sense, but with the benefit that the multiplexed immunohistochemistry signal, small molecular probe signal, and lectin histochemistry signal are more homogeneously distributed and deeply penetrated into the tissue, resulting in greater specificity of the staining to generate a higher signal-to-background ratio relative to an absence of the supramolecular histochemistry.

This process can be cyclically performed when combined with a procedure where stained tissue is recovered by reversing any optical tissue clearing, when employed, by washing using conventional solutions, and with the antibodies eluted with a solution containing the chaotrope plus a reducing agent, such as sulfite ions, β-mercaptoethanol, or tris(2-carboxyethyl)phosphine, in any solution of the desired composition at 20 to 55° C. for one hour to one week. After some washing the tissue can proceed to another round of supramolecular histochemistry as detailed above.

### Single Antibody

A whole mouse brain was perfusion-fixed with 4% paraformaldehyde and post-fixed overnight at 4 C. It was washed in phosphate buffered saline (PBS) with 0.02% w/v sodium azide (abbreviated as PBSN) three times for one hour for at room temperature. For pretreatment, the whole mouse brain was dehydrated in graded methanol, delipidated in 2:1 v/v volume of dichloromethane:methanol mixture overnight, then rehydrated in graded methanol. The tissue was then put into PBSN, and PBSN with 0.2M sodium closo-dodecahydrododecaborate and incubated at 37° C. overnight with gentle shaking. The incubation solution was refreshed with PBSN with 0.2M sodium closo-dodecahydrododecaborate and 10 μg rabbit primary antibody against a tissue antigen that is added, along with 10 μg donkey anti-rabbit secondary antibody's Fab fragment, which is fluorescently-labelled, for example, with Alexa Fluor 647 dye. Based on the amount of liquid added for the primary and secondary antibody reagents. A corresponding amount of 10× concentration of PBSN with 2.5M sodium closo-dodecahydrododecaborate can be supplemented to bring the concentration of the chaotrope closo-dodecahydrododecaborate to the desired level. The tissue was subsequently incubated at room temperature for three days, transferred into a solution with 0.25M 2-hydroxypropyl-7-cyclodextrin, incubated for one day, transferred into PBSN for washing for at least 1 hour, and dehydrated in graded methanol and optically cleared in benzyl alcohol/benzyl benzoate (BABB) clearing solution. The brain was subsequently imaged for the antigen stained using a selective plane illumination microscope.

### Single H&E

A 1×1×1 cm³ human tissue sample was obtained from a surgical specimen and immersion fixed in 10% neutral buffered formalin. The tissue was cleaned in PBS, dehydrated in graded ethanol, treated in 2:1 v/v dichloromethane:methanol overnight, and rehydrated in graded ethanol. The tissue was washed in PBS, placed in 1×TBE buffer with 0.1M potassium closo-dodecahydrododecaborate with 0.1% w/v eosin Y supplemented with 0.1M triethanolamine or 0.1M N-methylglucamine to be stained overnight, placed into a solution with 0.25M 2-hydroxypropyl-γ-cyclodextrin in 1×TBE buffer with 50% v/v tetrahydrofuran and 0.1M N-methylglucamine and incubated overnight, and transferred to 100% tetrahydrofuran for completing dehydration and optical cleared in dibenzyl ether. The tissue was subsequently imaged for general tissue morphology using a confocal microscope.

Alternatively, a 1×1×1 cm³ human tissue sample was obtained from a surgical specimen and immersion fixed in 10% neutral buffered formalin. The tissue was cleaned in PBS, dehydrated in graded ethanol, treated in chloroform overnight, and rehydrated in graded ethanol. The tissue was washed in TBE buffer, placed in 1×TBE buffer with 0.1M 2-hydroxypropyl-7-cyclodextrin with 50% v/v tetrahydrofuran, 0.1% w/v eosin Y, 0.1% w/v acridine orange, and 0.1M triethanolamine to be stained overnight, switched to 100% tetrahydrofuran for completing dehydration, and optical cleared in ethyl cinnamate. The tissue was imaged for general tissue morphology using a confocal microscope and with a selective plane illumination microscope.

Single antibody and small molecule dye A whole mouse kidney was dissected and fixed with graded methanol, treated with dichloromethane, and rehydrated with graded methanol and proceeded to post-fixation in 4% paraformaldehyde for two hours at 4 C. The kidney was washed in phosphate buffered saline (PBS) with 0.02% w/v sodium azide (abbreviated as PBSN) for one hour, placed into PBSN with 0.2M lithium closo-dodecahydrododecaborate, and incubated at 37° C. overnight with gentle shaking. The incubation solution was refreshed with PBSN with 0.25M sodium closo-dodecahydrododecaborate and 1 μg of mouse primary antibody against an added tissue antigen, along with 1 μg donkey anti-mouse secondary antibody's Fab fragment, which is fluorescently-labelled, for example, with CF488A dye. Simultaneously, an aqueous solution of DAPI dilactate salt is complexed with sulfobutylether-β-cyclodextrin by mixing for ten seconds in a separate tube, and rapidly adding to the antibody staining solution. Based on the amount of liquid added for the primary and secondary antibody reagents and the nucleic acid stain, a corresponding amount of PBSN with 2.5M sodium closo-dodecahydrododecaborate can be supplemented to bring the concentration of the chaotrope closo-dodecahydrododecaborate to a desired level. The tissue was incubated at room temperature overnight, transferred into a solution with 0.2M 2-hydroxypropyl-7-cyclodextrin, incubated for three hours, transferred into PBSN for washing for at least one hour, dehydrated in graded methanol, and optically cleared in benzyl alcohol/benzyl benzoate (BABB) clearing solution. The cleared kidney was imaged for the antigen stained using a selective plane illumination microscope. Single antibody, multiplexed lectin use and small molecule dye use.

A whole mouse kidney was perfusion-fixed with 4% paraformaldehyde in PBS, permeabilized with 10 mM sodium deoxycholate in 0.1M Tris buffer, washed thoroughly in 0.1M Tris buffer, placed into 0.1M HEPES buffer pH 8 with 0.25M cesium closo-dodecahydrododecaborate, and incubated at 37° C. for one hour with gentle shaking. The incubation solution was refreshed with 0.1M HEPES buffer pH 8 with 0.25M cesium closo-dodecahydrododecaborate, to which were added 1 μg of guinea pig primary antibody against a tissue antigen and 1 μg goat anti-guinea pig secondary antibody's Fab fragment, which is fluorescently-labelled, for example, with Atto 490LS dye. Simultaneously, an aqueous solution of oxazole blue was complexed with sulfobutylether-β-cyclodextrin by mixing for 10 seconds in a separate tube, and rapidly added to the antibody staining solution. Simultaneously, 10 μg of Griffonia simplicifolia lectin I tagged with AlexaFluor 488 dye, 5 μg of Phaseolus vulgaris hemagglutinin lectin tagged with Atto 647N dye, and 10 μg of succinylated Wheat germ agglutinin tagged with tetramethylrhodamine, were added to the staining solution containing the antibodies and supramolecularly complexed nucleic acid probe. Based on the amount of liquid added for the primary and secondary antibody reagents and the nucleic acid stain, a corresponding amount of PBSN with 2.5M sodium closo-dodecahydrododecaborate can be supplemented to bring the concentration of the chaotrope closo-dodecahydrododecaborate to the desired level. The tissue was then incubated at room temperature for 6 hours, transferred into a solution with 0.25M 2-hydroxypropyl-7-cyclodextrin and incubated for three hours, and washed thoroughly in PBSN. The tissue was the optically cleared in OPTIClear solution and imaged with a confocal microscope.

### Multiplexed Antibody and Multiplexed Lectin and Multiplexed Molecule Dye Use

A 2 mm-thick mouse brain tissue slice that was fixed was retrieved from archive and delipidated either with 4% sodium dodecyl solution or dichloromethane after tissue dehydration. The tissue was washed in PBSN, put into 0.25M sodium closo-dodecahydrododecaborate, and incubated at 32° C. for two hours. The incubation solution was refreshed with 0.25M sodium closo-dodecahydrododecaborate and stained. To the solution was added 3 μg of rabbit primary antibody, 3 μg of mouse primary antibody of the IgG1 isoform, 1 μg of mouse primary antibody of the IgG2a isoform, 3 μg of guinea pig primary antibody, 5 μg of goat primary antibody, 2 μg of chicken primary antibody, 2 μg of rat primary antibody, 3 μg of Lycopersicon esculentum lectin tagged with AlexaFluor 700 dye, 3 μg of Peanut agglutinin tagged with 7-aminocoumarin dye, and 1 picomole Hoechst 33342 dye complexed with 2.5 picomole sulfobutylether-β-cyclodextrin. Based on the expected amount of liquid added for the staining probe reagents, a corresponding amount of PBSN with 2.5M sodium closo-dodecahydrododecaborate was added to bring the concentration of the chaotrope to the desired level. Additionally, 3 μg of donkey anti-rabbit secondary antibody Fab fragment tagged with Atto 430LS, 3 μg of goat anti-mouse IgG1 secondary antibody Fab fragment tagged with AlexaFluor 555, 1 μg of goat anti-mouse IgG2a secondary antibody Fab fragment tagged with AlexaFluor 594, 3 μg of donkey anti-guinea pig secondary antibody Fab fragment tagged with Atto 490LS, 5 μg of bovine anti-goat Fc-specific secondary antibody Fab fragment tagged with BODIPY TMR, 2 μg of donkey anti-chicken IgY secondary antibody Fab fragment tagged with AlexaFluor 647, and 2 μg of donkey anti-rat secondary antibody Fab fragment tagged with AlexaFluor 680 were added to the staining mix. The tissue was incubated for 1 hour. The tissue was washed in a solution of 0.25M 2-hydroxypropyl-7-cyclodextrin in PBSN, washed with PBSN, dehydrated, optical tissue cleared in a benzyl alcohol/benzyl benzoate mixture, and imaged using a hyperspectral confocal imaging platform.

Multiplexed Antibody and Multiplexed Lectin without Supramolecular Complexation

A fixed 2 mm-thick mouse brain tissue slice was retrieved from archive and delipidated with 4% sodium dodecyl solution or with dichloromethane after tissue dehydration. The tissue was washed in PBSN, put into 0.25M sodium closo-dodecahydrododecaborate solution, and incubated at 37° C. for two hours. The incubation solution was refreshed with 0.25M sodium closo-dodecahydrododecaborate and stained. To the solution was added 3 μg of rabbit primary antibody, 3 μg of Lycopersicon esculentum lectin tagged with AlexaFluor 700 dye, 3 μg of Peanut agglutinin tagged with 7-aminocoumarin dye, and 1 picomole Hoechst 33342 dye complexed with 2.5 picomole sulfobutylether-β-cyclodextrin. Based on the expected amount of liquid added for the staining probe reagents, a corresponding amount of PBSN with 2.5M sodium closo-dodecahydrododecaborate was added to bring the concentration of the chaotrope to the desired level. Additionally, 3 μg of donkey anti-rabbit secondary antibody Fab fragment tagged with Atto 430LS, was added to the staining mix. The tissue was incubated for 6 hours. The tissue was washed in PBSN where the effect of the closo-dodecahydrododecaborate was diluted, washed with PBSN, dehydrated, optical tissue cleared in a benzyl alcohol/benzyl benzoate mixture, and imaged using a confocal imaging platform.

### Iterative Multiplexed Antibody and Multiplexed Lectin and Multiplexed Molecule Dye Use

The tissue was processed as indicated above with any combination of the staining reagents and processed through the optical clearing step and imaging. The tissue was washed in methanol, rehydrated through graded methanol, washed adequately in PBS, and subjected to another cycle of supramolecular histochemistry as above with any combination of the mentioned staining reagents, being proceeded through the optical clearing step and imaging. The procedure cycled eight times for the same tissue sample.

Multiplexed Antibody and Lectin and Small Molecule Dyes Use with Subsequent Downstream Applications (FISH)

The tissue was processed as above with any combination of the staining reagents and processed through the optical clearing step and imaging. The tissue was then examined with single molecule fluorescent in situ hybridization for the detection of transcript molecules in situ using either a published hairpin chain reaction method or using any commercial system (Stellaris or ACDLabs RNAScope).

### Illustrative Example for Large Pieces of Human Tissues

A 3.5 cm×2.5 cm×1.8 cm piece of human brainstem was harvested from a cadaver, fixed in neutral buffered formalin for two weeks and washed substantially in PBS. To record the tissue image, the tissue was embedded in 2% agarose, imaged using a magnetic resonance imaging, retrieved by manually rubbing the agarose gel from the sample, and washed substantially with PBSN. The tissue was incubated in PBSN with 0.5M sodium closo-dodecahydrododecaborate for one week at 37° C. with gentle shaking. Subsequently the solution was replaced with PBSN with 0.25M sodium closo-dodecahydrododecaborate, to which 100 μg rabbit primary antibody, 50 μg mouse primary antibody, 100 μg Griffonia simplicifolia I lectin tagged with tetramethylrhodamine, 50 picomole DAPI dilactate complexed with the host molecule sulfobutylether-β-cyclodextrin, 0.1% w/v solution eosin Y complexed with γ-cyclodextrin, 100 μg of donkey anti-rabbit secondary antibody Fab fragment tagged with AlexaFluor 488, or 50 μg of donkey anti-mouse secondary antibody Fab fragment tagged with SeTau 647 was added to the mixture and the tissue was incubated for one week at room temperature with gentle shaking. The tissue was washed in a solution with 0.25M 2-hydroxypropyl-7-cyclodextrin, 0.1M 7-cyclodextrin and PBSN for one week at room temperature with gentle shaking, further washed in PBSN for two days at room temperature, and imaged using two-photon tomography.

### Illustrative Example for FFPE-Retrieved Human Tissues

A piece of breast cancer tissue was retrieved from a paraffin-wax embedded block that has previously been formalin fixed. The block was heated to temperatures below 100° C. to melt the wax and retrieve the tissue, washed substantially in xylene or limonene to remove any traces of wax, delipidated in dichloromethane/methanol, rehydrated through graded isopropanol, washed in water and PBSN, and proceeded to multiplexed supramolecular histochemistry as in the multiplexed antibody and multiplexed lectin and multiplexed molecule dye use experiment, above.

### Illustrative Example for Fresh Frozen Tissues

A piece of high-grade glioma tissue was obtained freshly from a neurosurgery and stored at −80° C. before transported to our facilitating for processing. The tissue was then thawed, immersed in 4% paraformaldehyde in PBS for fixation overnight, dehydrated in graded methanol, delipidated in dichloromethane/methanol, rehydrated through graded methanol, washed in PBSN, and proceeded to multiplexed supramolecular histochemistry as in the multiplexed antibody and multiplexed lectin and multiplexed molecule dye use experiment, above.

All documents referred to or cited herein are incorporated by reference in their entirety, including all figures and tables, to the extent they are not inconsistent with the explicit teachings of this specification. It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

Lai, H. M., Tang, Y., Lau, Z. Y. H., Campbell, R. A. A., Yau, J. C. N., Chan, D. C. W., Wong, H. K. T., Yan, L. Y. C., Wu, W. K. K., Wong, S. H., Kwok, K. W., Wing, Y. K., Ng, H. K., Mrsic-Flogel, T. D., Mok, V. C. T., Chan, J. Y. K., Ko, H. 2022. Antibody stabilization for thermally accelerated deep immunostaining. Nature Methods. 19: 1137.
Lee, K., Lai, H. M., Soerensen, M., Hui, E., Cho, W., Ma, V., Ho, J., Chang, R. C. 2020. Optimized Tissue Clearing Minimizes Distortion and Destruction During Tissue Delipidation. Neuropathol. Appl. Neurobiol. doi.org/10.1111/nan.12673.
Lai, H. M., Liu, A. K. L. L., Ng, H. H. M., Goldfinger, M. H., Chau, T. W., DeFelice, J., Tilley, B. S., Wong, W. M., Wu, W., Gentleman, S. M. 2018. Next generation histology methods for three-dimensional imaging of fresh and archival human brain tissues. Nat. Commun. 9: 1066.
Lai, H. M., Ng, W. L., Gentleman, S. M., Wu, W. 2017. Chemicals Probes for Visualizing Intact Animal and Human Brain Tissue. Cell Chem. Biol. 24: 659-672.
Liu, A. K. L., Lai, H. M., Chang, R. C., Gentleman, S. M. 2016. Free-of-acrylamide SDS-based Tissue Clearing (FASTClear): A novel protocol of tissue clearing for three-dimensional visualisation of human brain tissues. Neuropathol. Appl. Neurobiol. 43: 346-351.
Barba-Bon, A., Salluce, G., Lostalé-Seijo, I., Assafl, K. I., Hennig, A., Montenegro, J., Nau, W. M. 2022. Boron clusters as broadband membrane carriers. Nature 603: 637.

We claim:

1. A supramolecular histochemistry system for staining, comprising at least one probe, at least one chaotropic ion and, optionally, at least one complexing agent, wherein the at least one probe achieves a penetration throughout a tissue with a homogeneous distribution in the tissue for a high specificity of tissue staining.

2. The supramolecular histochemistry system for staining according to claim 1, wherein the at least one probe is a plurality of probes, the at least one chaotropic ion is a chaotropic ion, and/or optionally the at least one complexing agent is a plurality of complexing agents.

3. The supramolecular histochemistry system for staining according to claim 1, wherein the chaotropic ion is a derivative of any unsubstituted closo-borane with more than 9 atoms, closo-carborane with more than 9 atoms, any mixture thereof, or any derivative thereof where boron or carbon atoms are independently substituted with hydrogen, fluorine, chlorine, bromine, iodine, hydroxy group, amino group, or alkyl group.

4. The supramolecular histochemistry system for staining according to claim 3, wherein the chaotropic ion is closo-dodecaborate.

5. The supramolecular histochemistry system for staining according to claim 1, wherein the complexing agent comprises a cyclodextrin, cucurbituril, calixarene, cyclophane, cryptand, cryptophane, a chemical derivative of any thereof, an oligomer with anion associating repeating units, or any mixture thereof.

6. The supramolecular histochemistry system for staining according to claim 5, wherein the cyclodextrin is a hexakis-β-glucopyranose (α-cyclodextrin), heptakis-β-glucopyranose β-cyclodextrin), octakis-β-glucopyranose (γ-cyclodextrin), wherein independently one or more hydroxy group is optionally replaced with amino, methoxy, (2-hydroxy)propoxyl, sulphato, guanidino, acetato, acetamido, azido, bromo, iodo, chloro, toluenesulfonyl, thiol, succinyl, phosphato, 4-sulfatobutoxy, carboxymethoxy, or (2-aminoethyl)amino group.

7. The supramolecular histochemistry system for staining according to claim 6, wherein the cyclodextrin is (2-hydroxypropyl)-7-cyclodextrin.

8. The supramolecular histochemistry system for staining according to claim 1, wherein the plurality of probes comprises a primary antibody, an antigen, a lectin, a functionalized antibody, an oligopeptide, a small molecule dye, and/or a fluorescent DNA stain.

9. The supramolecular histochemistry system for staining according to claim 1, further comprising a chemical buffer system.

10. The supramolecular histochemistry system for staining according to claim 9, wherein the chemical buffer system comprises Good's buffering agents, phosphate-buffered saline, Tris, CAPS, HEPES, or any combination thereof.

11. The supramolecular histochemistry system for staining according to claim 10, wherein the buffer system has a pH 6-11 and is in a concentration of 10-1000 mM.

12. The supramolecular histochemistry system for staining according to claim 9, wherein the chemical buffer system comprises 1×PBS at pH 7-8.

13. The supramolecular histochemistry system for staining according to claim 1, wherein the chaotropic ion and the complexing agent are provided in separate vehicles.

14. A method for performing histology comprising:
providing a supramolecular histochemistry system for staining according to claim 1;
providing a tissue comprising sample;
incubating the tissue comprising sample with the chaotropic ion of the histochemistry system to form an incubated sample;
combining the incubated sample with a chemical buffer system with optional inclusion of the complexing agent of the supramolecular histochemistry system to promote an association of the probe with a target to generate a signal; and
imaging the signal.

15. The method according to claim 14, wherein combining is diluting without the complexing agent.

16. The method according to claim 14, wherein the tissue comprising sample is a tissue slice of about 1 to about 50,000 μm in thickness obtained by frozen sectioning, vibratome sectioning, or paraffin sectioning, or processing as an intact organ.

17. The method according to claim 14, wherein the tissue comprising sample is fixed using formalin-fixation, glutaraldehyde-fixation, methanol-fixation, ethanol-fixation, glyoxal-fixation, picric acid-fixation, trichloroacetic acid-fixation, polyacrylamide-formalin-fixation, polyglycerol 3-polyglycidyl ether-fixation, or any combination thereof.

18. The method according to claim 14, further comprising optical tissue clearing.

19. The method according to claim 14, wherein combining is subsequent to incubating.

20. The method according to claim 14, wherein the probe is provided with the chaotropic ion for co-diffusion into the tissue.

21. The method according to claim 14, wherein the probe is provided as a complex with the complexing agent for enhanced migrating of the probe through the tissue.
